(19) United States
(12) Patent Application Publication
(10) Pub. No.: US 2005/0231632 A1
(43) Pub. Date: Oct. 20, 2005

(54) Image-taking device, information processor, mobile terminal, image-taking method and image-taking program

(75) Inventors: Kenichi Sekikawa, Kawasaki (JP); Makoto Ishida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/151,247

(22) Filed: Jun. 14, 2005

Related U.S. Application Data
(63) Continuation of application No. PCT/JP03/06465, filed on May 23, 2003.

(51) Int. Cl. H04N 5/222

(52) U.S. Cl. 348/370

(57) ABSTRACT

An image-taking device that takes an image of an object under an external light source comprises: an illuminating section 170 that emits a light to the object; a camera 110 that takes an image of the object and outputs acquired image information; a filter section 130 that extracts a fluctuation component caused by an external light source based on a signal obtained by smoothing the brightness of the image information; a light amount control section 140 that controls the light amount of the illuminating section 170 so that the fluctuation component is corrected, based on a signal obtained by reversing the fluctuation component.

### TECHNICAL FIELD

The present invention relates to an image-taking device, an information processor, a mobile terminal, an image-taking method and an image-taking program, and in particular to an image-taking device having a function of removing flickers caused in the case of taking an image under an external light source driven by an alternating-current power supply, an information processor and a mobile terminal which are mounted with the image-taking device, an image-taking method and an image-taking program.

### BACKGROUND ART

When an image is taken under an external light source driven by an alternating-current power supply, flickers are caused by difference between the blinking cycle of the external light source and the frame cycle of the camera, and thereby fluctuation is caused in the brightness of the acquired image.

Accordingly, there has been proposed a technique of detecting whether or not there are flickers and giving a sufficient illuminance to an object by emitting a flash, if it is determined there are flickers, to prevent an image from being darkened (see Patent Document 1, for example).

[Patent Document 1]

Japanese Patent Laid-Open No. 10-126684 (pp. 2-4; FIG. 1)

However, in the prior-art technique described above, since a flash is emitted to give a sufficient illuminance to an object whenever flickers are detected, much power is consumed and, therefore, it takes much time to charge the flash unit. Consequently, the flash unit cannot emit a flash when images are continuously taken such as in the case of animation, and as a result, the problem of fluctuation in the brightness of the taken images is caused. Furthermore, since a large amount of light is forcedly given, the brightness of the entire image is high.

The present invention has been made to solve such a problem, and its object is to provide an image-taking device capable of minimizing required power consumption and continuously keeping the illuminance on an object constant by correcting the fluctuation in illuminance caused by an external light source driving by an alternating-current power supply, an information processor and a mobile terminal which are mounted with the image-taking device, an image-taking method and an image-taking program.

### DISCLOSURE OF THE INVENTION

The present invention is an image-taking device that takes an image of an object, comprising: an illuminating section that emits a light to the object; a camera that takes an image of the object and outputs acquired image information; a filter section that extracts a fluctuation component caused by an external light source from the brightness of the image information; and a light amount control section that controls the light amount of the illuminating section so that the fluctuation component is corrected.

According to the configuration, for example, by causing a light to be emitted so that the reduced amount in fluctuation of illuminance of an external light source is compensated, it is possible not only to continuously keep the illuminance on an object constant but also to minimize required power consumption. Thereby, even in the case of continuously taking images or taking animation, it is possible to continue light emission by the illuminating section longer and prevent image brightness fluctuation due to flickers. The illuminating section of this embodiment is configured by an illumination driving section 160 and an illuminating section 170.

Furthermore, in the image-taking device according to the present invention, the light amount control section can be characterized in controlling the light amount of the illuminating section based on a signal obtained by reversing the fluctuation component.

According to the configuration, it is possible to easily control the light amount of the illuminating section with the use of a brightness fluctuation component.

In the image-taking device according to the present invention, the filter section can be characterized in extracting the fluctuation component based on a signal obtained by smoothing the brightness.

According to the configuration, it is possible to easily extract a component of brightness fluctuation caused by influence of an external light source. The image-taking devices of the present invention includes a digital camera or a digital video camera.

Furthermore, the present invention is an information processor having a function of performing information processing as well as a function of performing image taking, the information processor comprising: an input section that accepts user input; and an image-taking device that takes an image in accordance with the user input and has an illuminating section that emits a light to an object, a camera that takes an image of the object and outputs acquired image information, a filter section that extracts a fluctuation component caused by an external light source from the brightness of the image information, and a light amount control section that controls the light amount of the illuminating section so that the fluctuation component is corrected.

In this case, as the information processor, a notebook-type personal computer, a mobile telephone, a PHS, a PDA (personal digital assistant) and the like are included.

Furthermore, the present invention is a mobile terminal having a function of performing communication with the outside as well as a function of performing image taking, the mobile terminal comprising: an input section that accepts user input; an image-taking device that takes an image in accordance with the user input and has an illuminating section that emits a light to an object, a camera that takes an image of the object and outputs acquired image information, a filter section that extracts a fluctuation component caused by an external light source from the brightness of the image information, and a light amount control section that controls the light amount of the illuminating section so that the fluctuation component is corrected; a storage section that stores the image information; a display section that displays the image information; and a communication section that performs communication of the image information with the outside.

In this case, as the mobile terminal, a mobile personal computer, a mobile telephone, a PHS, a PDA and the like are included.

Furthermore, the present invention is an image-taking method that takes an image of an object under an external light source in which the light amount fluctuates, the method comprising: emitting a light to the object; taking an image of the object and outputting acquired image information; extracting a fluctuation component caused by an external light source from the brightness of the image information; and controlling the amount of the emitted light so that the fluctuation component is corrected.

Furthermore, the present invention is an image-taking program stored in a computer-readable medium in order to cause a computer to perform an image-taking method that takes an image of an object under an external light source in which the light amount fluctuates, the program causing the computer to perform the steps of: emitting a light to the object; taking an image of the object and outputting acquired image information; extracting a fluctuation component caused by an external light source from the brightness of the image information; and controlling the light amount of the emitted light so that the fluctuation component is corrected.

In the image-taking program described above, as the computer-readable medium, portable storage media such as a CD-ROM, a flexible disk, a DVD disk, a magneto-optical disk and an IC card, databases in which computer programs are retained, other computers and their databases, and a transmission medium on a line are also included, in addition to semiconductor memories such as a ROM and a RAM.

### BRIEF DESCRIPTION OF THE DRAWINGS

FIG. 1 is a block diagram showing an example of configuration of a mobile terminal mounted with an image-taking device according to the present invention;

FIG. 2 is a block diagram showing an example of configuration of the image-taking device according to the present invention; and

FIG. 3 shows waveform examples for describing the operation of the image-taking device according to the present invention.

### BEST MODE FOR CARRYING OUT THE INVENTION

An embodiment of the present invention will be described below in detail with reference to the drawings. In this embodiment, description will be made on a case where an image-taking device according to the present invention is mounted on a mobile terminal. As examples of the image-taking device, there are a digital camera and a digital video camera. As examples of the mobile terminal mounted with a digital camera or a digital video camera, there are a mobile telephone, a PDA (personal digital assistant) and a mobile (notebook-type) personal computer having a communication function. An information processor of the present invention is configured by a notebook-type personal computer whether the note-book-type personal computer has a communication function or not.

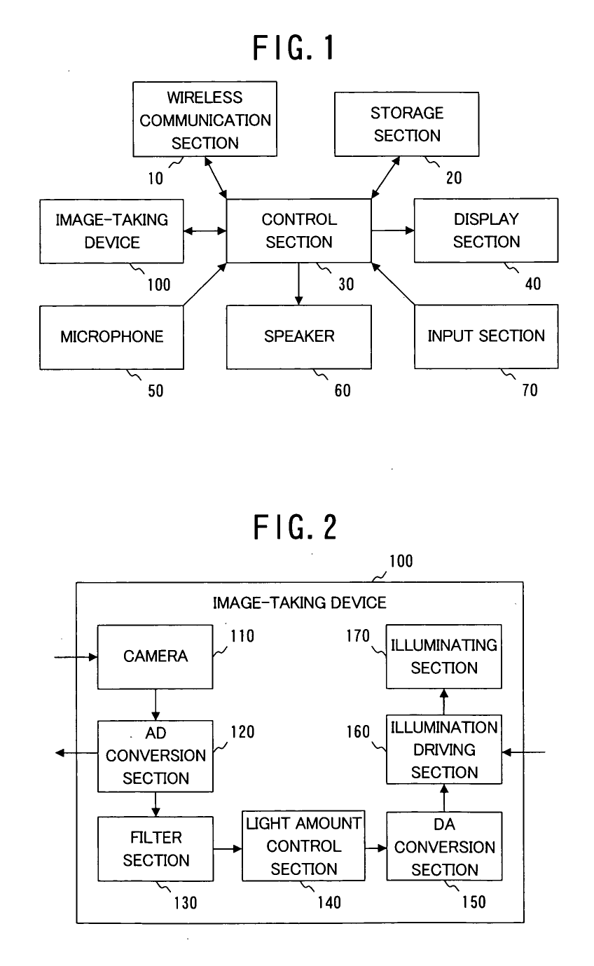

FIG. 1 is a block diagram showing an example of configuration of a mobile terminal mounted with an image-taking device according to the present invention. The mobile terminal has, for example, the configuration of a mobile telephone and is configured by a wireless communication section 10 that performs wireless communication of voices or images between the mobile terminal and the outside, a storage section 20 that stores programs, images, a telephone book and the like required for the operation of the mobile terminal, a control section 30 that controls image-taking, wireless communication and the like of the mobile terminal, a display section 40 that displays an image or characters, a microphone 50 that acquires voices from the outside, a speaker 60 that outputs voices to the outside, an input section 70 that accepts user input for image-taking, wireless communication and the like, and an image-taking device 100 that performs image taking.

Description will be now made on the image-taking operation in the mobile terminal according to the present invention. First, a user inputs an image-taking instruction using the input section 70. Then, the control section 30 outputs the image-taking instruction to the image-taking device 100. Then, the image-taking device 100 performs image taking, and the control section 30 outputs a digital brightness signal acquired from the image-taking device 100 as an image to the storage section 20. The storage section 20 stores the image. Then, the control section 30 outputs the stored image from the storage section 20 to the display section 40. The display section 40 displays the image.

The configuration of the image-taking device 100 will be now described. FIG. 2 is a block diagram showing an example of configuration of the image-taking device according to the present invention. The image-taking device 100 is configured by a camera 110, an AD conversion section 120, a filter section 130, a light amount control section 140, a DA conversion section 150, an illumination driving section 160 and an illuminating section 170. The illuminating section 170 is configured by an LED, for example.

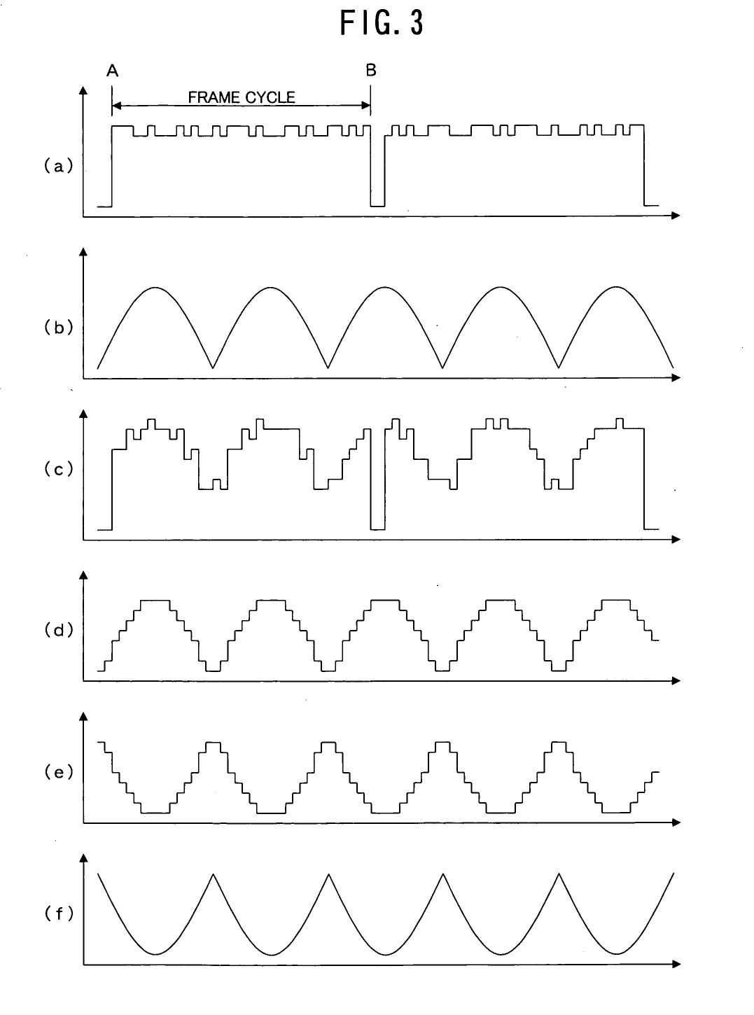

The operation of the image-taking device 100 will be now described in detail with the use of waveforms (a) to (f) in FIG. 3. The horizontal axis of the waveforms (a) to (f) indicates time. Here, description will be made on the case where image taking is performed under an external light source driven by an alternating-current power supply.

First, when an image-taking instruction is inputted from the control section 30 to the image-taking device 100, the illumination driving section 160 causes the illuminating section 170 to illuminate an object. The camera 110 takes an image of the object and outputs an obtained analog brightness signal to the AD conversion section 120. The AD conversion section 120 converts the analog brightness signal to a digital brightness signal and outputs it to the filter section 130 and the control section 30. Here, on the assumption of an ideal external light source without illuminance fluctuation, an ideal brightness of the digital brightness signal obtained under this external light source is denoted by (a). In (a), the portion from a point A to a point B indicates a frame cycle. Meanwhile, if the illuminance by the external light source driven by the alternating-current power supply is supposed to be (b), the brightness of a digital brightness signal obtained under this external light source is denoted by (c). Thus, (c) shows a fluctuating waveform because the ideal digital brightness signal (a) is influenced by the illuminance (b) by the external light source by an alternating-current power supply.

Then, the filter section 130 extracts a brightness fluctuation component from the digital brightness signal by smoothing it and outputs an obtained fluctuation component signal to the light amount control section 140. Here, the fluctuation component signal obtained by smoothing the digital brightness signal (c) is denoted by (d).

Then, the light amount control section 140 reverses the fluctuation component signal to generate a digital light amount control signal for correcting the illuminance of the external light source, and outputs it to the DA conversion section 150. In this case, the digital light amount control signal obtained by reversing the fluctuation component signal (d) is denoted by (e).

Then, the DA conversion section 150 converts the digital light amount control signal to an analog light amount control signal and outputs it to the illumination driving section 160. The illumination driving section 160 drives the illuminating section 170 in accordance with the analog light amount control signal, and thereby the illuminating section 170 emits an adjusted amount of light. The analog light amount control signal obtained based on the digital light amount control signal (e) is denoted by (f). Thus, by driving the illuminating section 170 in accordance with the analog light amount control signal (f) to perform subsequent image taking, the fluctuating digital brightness signal (c) comes close to the digital brightness signal (a) that does not fluctuate.

As described above, in the case where the illuminance on an object fluctuates due to influence of an external light source which is driven by an alternating-current power supply and in which the light amount fluctuates, it is possible to continuously keep the illuminance on the object constant by adjusting the light amount of the illuminating section 170 so that the illuminance fluctuation is corrected.

In this embodiment, as an image-taking program, there is provided a program that causes the control section 30 to perform the steps of: emitting a light to an object by means of the illumination driving section 160 (S1), taking an image of the object by means of the camera 110 and outputting acquired image information (S2), extracting a fluctuation component caused by an external light from the brightness of the image information by means of the filter section 130 (S3), and controlling the amount of the light emitted by the illumination driving section 160, by means of the light amount control section 140 so that the fluctuation component caused by the external light source is corrected (S4), as the operation described above, and an image-taking method is provided by the methods performed at respective steps.

The filter section 130 in this embodiment is assumed to extract a fluctuation component of the brightness by performing smoothing. However, the fluctuation component of the brightness may be extracted with the use of a different signal processing. The light amount control section may be configured only by a hardware circuit that performs signal processing.

### INDUSTRIAL APPLICABILITY

As described above, according to the present invention, the illuminating section is caused to emit a light so that fluctuation in the amount of light from an external light source is corrected, and thereby the illuminance of an object is kept constant. Accordingly, it is possible not only to continuously keep the illuminance on the object constant but also to minimize power required for illumination and reduce the amount of charge. Thus, even in the case of continuously taking images or taking animation, it is possible to continue light emission of the illuminating section longer and prevent fluctuation in the brightness of an image due to flickers.

1. An image-taking device that takes an image of an object, comprising:
an illuminating section that emits a light to the object;
a camera that takes an image of the object and outputs acquired image information;
a filter section that extracts a fluctuation component caused by an external light source from the brightness of the image information; and
a light amount control section that controls the light amount of the illuminating section so that the fluctuation component is corrected.

2. The image-taking device according to claim 1, wherein
the light amount control section controls the light amount of the illuminating section based on a signal obtained by reversing the fluctuation component.

3. The image-taking device according to claim 2, wherein
the filter section extracts the fluctuation component based on a signal obtained by smoothing the brightness.

4. An information processor having a function of performing information processing as well as a function of performing image taking, the information processor comprising:
an input section that accepts user input; and
the image-taking device according to claim 1 that takes an image in accordance with the user input.

5. A mobile terminal having a function of performing communication with the outside as well as a function of performing image taking, the mobile terminal comprising:
an input section that accepts user input;
the image-taking device according to claim 1 that takes an image in accordance with the user input;
a storage section that stores the image information;
a display section that displays the image information; and
a communication section that performs communication of the image information with the outside.

6. An image-taking method that takes an image of an object under an external light source, the method comprising:
emitting a light to the object;
taking an image of the object and outputting acquired image information;
extracting a fluctuation component caused by an external light source from the brightness of the image information; and
controlling the light amount of the emitted light so that the fluctuation component is corrected.

7. An image-taking program stored in a computer-readable medium in order to cause a computer to perform an image-taking method that takes an image of an object under an external light source, the program causing the computer to perform the steps of:
emitting a light to the object;
taking an image of the object and outputting acquired image information;
extracting a fluctuation component caused by an external light source from the brightness of the image information; and
controlling the light amount of the emitted light so that the fluctuation component is corrected.
